(19) United States
(12) Patent Application Publication
(10) Pub. No.: US 2017/0187700 A1
(43) Pub. Date: Jun. 29, 2017

(54) PREGENERATED TWO-FACTOR AUTHENTICATION TOKENS

(71) Applicant: PAYPAL, INC., San Jose, CA (US)

(72) Inventor: Srini Rangaraj, Cupertino, CA (US)

(21) Appl. No.: 14/981,725

(22) Filed: Dec. 28, 2015

(51) Int. Cl. H04L 29/06

(52) U.S. Cl. CPC H04L 63/08; H04L 63/102

(57) ABSTRACT

Systems and methods for authenticating a user are provided. A user requests pregenerated tokens from a service provider and selects one or more conditions of use (e.g., time, location, and number of uses) to be attached to the pregenerated tokens. The service provider transmits the pregenerated tokens to the user for storing on the user device that requested the pregenerated tokens. When the user attempts to log in to the service provider, the user device selects the appropriate pregenerated token based on the conditions of use. The service provider checks whether the conditions of use attached to the token are met before authenticating the user.

### BACKGROUND

Field of the Invention

The present invention generally relates to verification of user identity, and more particularly to verification of user identity using a pregenerated token stored on a specific user device and associated with conditions of use, especially time bound.

Related Art

There are a variety of technologies available to authenticate remote users in order to enforce secure access control. These range from simple, single factor authentication (such as use of a password) to multiple factor authentication (such as use of a physical token in conjunction with a Personal Identification Number (PIN)). It is widely accepted that single factor authentication offers limited assurance as it is vulnerable to a wide range of attacks, many of which are neither sophisticated nor expensive to mount (such as “shoulder surfing” or eavesdropping). Most online services, however, still rely on single factor authentication because it appears to be the cheapest to implement—although this is usually because the subsequent cost of dealing with systematic attacks has not been considered.

In a typical conventional two-factor authentication system, a user is equipped with an authentication token. The authentication token may be implemented as a small, hand-held device that displays a series of passwords over time. These passwords may be one-time passwords. A user equipped with such an authentication token reads the currently displayed password and enters it into a computer or other element of an authentication system as part of an authentication operation. The user is also generally required to enter a PIN. Two-factor authentication is thus based on something the user has (e.g., the authentication token) and something the user knows (e.g., the PIN).

Three-factor authentication systems are also available, where the third factor required for successful authentication relates to a physical characteristic of the user, or in other words, something the user is (e.g., a fingerprint).

Conventional authentication tokens include both time-based tokens and event-based tokens. In a typical time-based token, the displayed passwords are based on a secret value and the time of day. A verifier with access to the secret value and a time of day clock can verify that a given presented password is valid. In a typical event-based token, the displayed passwords are based on a secret value and an event counter. The event counter may count the number of occurrences of a particular event, such as a user pressing a button on the token. A verifier with access to the secret value and the current event count can verify that a given presented password is valid.

A problem that can arise for users equipped with authentication tokens is that such users may want to authenticate to a given system without having physical possession of an operative token. For example, the user may have temporarily misplaced the token, forgotten to bring it home from the office or vice-versa, left it in the car, etc. Also, the token may break, or its battery may become depleted, etc. However, conventional authentication systems, such as the two-factor and three-factor systems noted above, generally require that the user be in physical possession of an operative token in order to authenticate.

Accordingly, a need exists for an authentication system that can securely authenticate users of two-factor systems without such users being in physical possession of respective operative authentication tokens.

### BRIEF DESCRIPTION OF THE FIGURES

FIGS. 1A-1C are sample screenshots illustrating a user enrolling in a pregenerated token authentication service and subsequently being authenticated according to an embodiment of the present disclosure;

FIG. 2 is a block diagram illustrating a system for authenticating a user with a pregenerated token according to an embodiment of the present disclosure;

FIG. 3 is a flowchart showing a method of authenticating a user with a pregenerated token according to an embodiment of the present disclosure; and

FIG. 4 is a block diagram of a system for implementing one or more components in FIG. 1 according to an embodiment of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure provides systems and methods that allow a user to electronically authenticate himself or herself to an application without carrying a physical token-generating device. The token can be of various lengths and may be random. The token can be based on various parameters, such as device, location, and language. In some embodiments, the token is a pre-fixed or post-fixed secret code. The token may include a combination of letters, numbers, and special characters. In one embodiment, the token is a non-predictable, random, and/or secret code or key. The code or key may be any combination of letters, numbers, and characters (e.g., an alphanumeric code) and may be in any language. For example, the code may be in Chinese for Chinese-speaking users and English for English-speaking users. The code can be unique for each use and can be associated with certain conditions (e.g., location, number of transactions, time, etc.) that must be met for the token to be used. Thus, observation or interception of the token is useless to the party intercepting the code, because the code generally cannot be used a second time.

In various embodiments, a service provider receives a request from a user to enroll in a pregenerated token authentication service. The user may log on to a website of a service provider and provide login credentials (e.g., username and password or PIN). The user is authenticated by the service provider, and navigates to a page that allows the user to request the pregeneration of tokens. The user may then select one or more conditions to associate with use of the token.

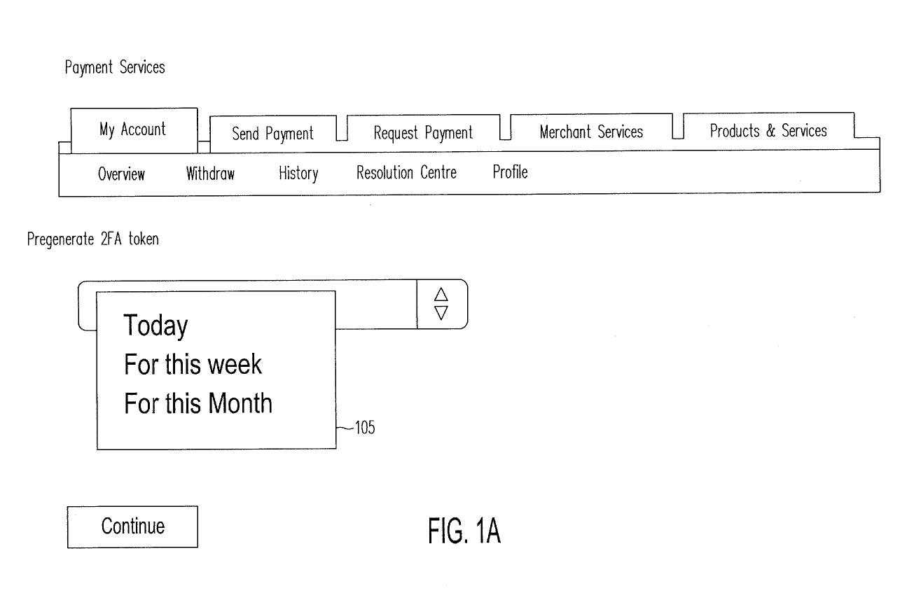

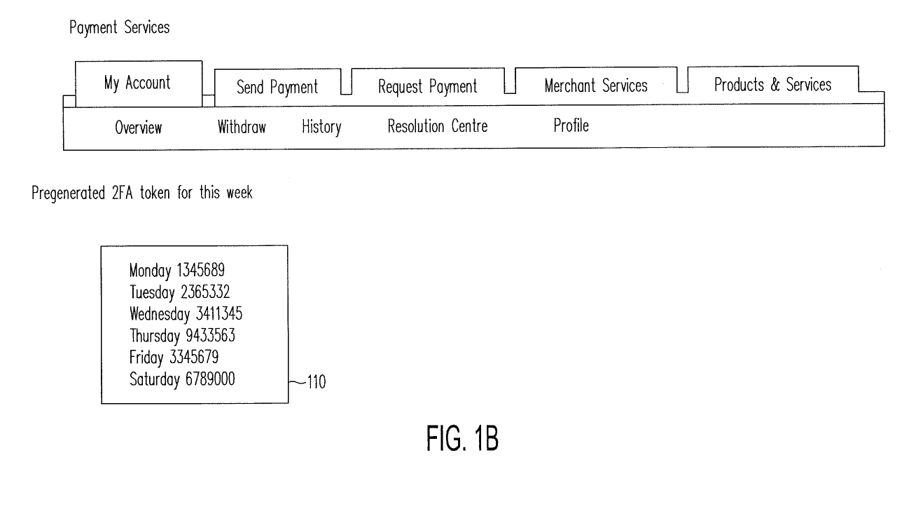

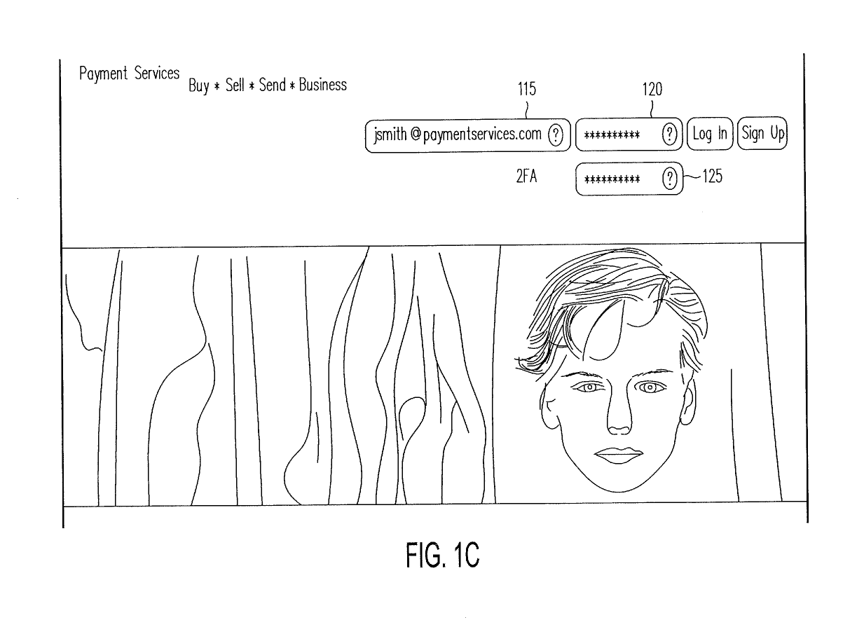

Referring to FIG. 1A, a service provider page is shown where the user selects time as a condition of use. As illustrated, the service provider provides the user with an option of picking a time 105 (e.g., for today, for this week, for this month). In this example, the user selects every week. In FIG. 1B, the service provider then generates a list of tokens 110 based on the selected time and transmits the list to the user for storing on a user device (e.g., in a cache or as cookies in a web browser). In this example, a token is generated for each day of the week. In other examples, a token may be generated for each hour of the day, for each half hour of the day, or for any suitable amount of time. The next time the user wants to log on to the service provider, as shown in FIG. 1C, the user inputs a username 115 and password 120. The user device retrieves the appropriate token based on the day of the week and enters the appropriate token 125 on the log in page. Should an unauthorized user steal and attempt to use the token, depending on the day of the week, the token would work for only a limited time or not work at all.

In some embodiments, the service provider page may request both the previous token and the next token. This may be the case where the user requests to log in right before the token is expected to change or expire. For example, in a case where the token changes every day, a user may request authentication at 11:59 pm on Monday night. The user device can retrieve and enter both the token for Monday and for Tuesday.

Advantageously, the present systems and methods are easy to use and require little action from the user. The pregenerated tokens are typically short-lived so an unauthorized user cannot do much with a stolen token. Thus, the pregenerated token assists in breaking open through a session and leading off attacks from identity thieves. The pregenerated tokens are tied to a user and in some embodiments, are time bound, in case an attacker gets hold of a pregenerated token that is either expired, intended for the future, or belongs to some other user. This is very useful business intelligence to detect if there is an attack. These increased security benefits are passed along to merchants, who are seamlessly integrated into the pregenerated token authentication service.

Moreover, the pregenerated tokens are specifically linked or tied to the user device (e.g., stored on the user device). If a user has two devices that he or she uses to log in to a service provider site, the user will have two sets of pregenerated tokens (one set for each device). For example, assume the user has a smartphone and a desktop computer that he or she uses to regularly sign in with the service provider. The service provider generates one set of tokens to be stored on the smartphone and a different set of tokens to be stored on the desktop. The user cannot use the tokens stored on the desktop to log in on the smartphone and cannot use the tokens stored on the smartphone to log in on the desktop.

As such, embodiments described herein address problems created by technology through a solution rooted in computer technology. In particular, the problems associated with electronic authentication (e.g., theft of user names and passwords, greater security needs, etc.) are created by technology and require a more robust way to identify an individual electronically and remotely. The solutions to these problems are rooted in computer technology and are directed to methods of addressing specific problems associated with electronic authentication. For example, associating a token with a condition of use and a specific device for two-factor authentication is not conventional. The present disclosure describes a two-factor authentication scheme where “something the user has” is his or her own user device (rather than a separate token-generating device) and something the user knows is his or her username and password, which is unconventional.

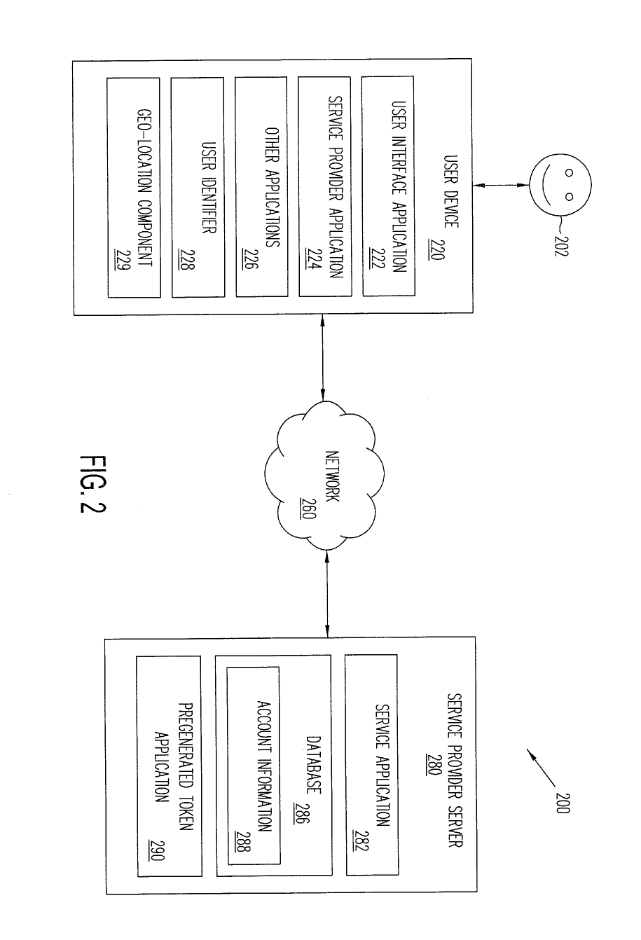

FIG. 2 shows one embodiment of a block diagram of a network-based system 200 that is configured to authenticate an individual with pregenerated tokens according to an embodiment of the present disclosure. Any of the systems or machines shown in FIG. 2 may be, include, or otherwise be implemented in a special-purpose (e.g., specialized or otherwise non-generic) computer that has been modified to perform one or more functions described herein for that system or machine. As shown, system 200 may comprise or implement a plurality of servers and/or software components that operate to perform various methodologies in accordance with the described embodiments. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

As shown in FIG. 2, system 200 includes a user device 220 (e.g., a smartphone) and at least one service provider server or device 280 (e.g., network server device) in communication over a network 260. Network 260, in one embodiment, may be implemented as a single network or a combination of multiple networks. For example, in various embodiments, network 260 may include the Internet and/or one or more intranets, landline networks, wireless networks, and/or other appropriate types of communication networks. In another example, network 260 may comprise a wireless telecommunications network (e.g., cellular phone network) adapted to communicate with other communication networks, such as the Internet.

User device 220, in one embodiment, is utilized by a user 202 to interact with service provider server 280 over network 260. User device 220, in various embodiments, may be implemented using an appropriate combination of hardware and/or software configured for wired and/or wireless communication over network 260 and for performing the functions described herein. In various implementations, user device 220 may include at least one of a smartphone, wireless cellular phone, satellite phone, tablet (e.g., iPad™ from Apple®), laptop computer, wearable device (e.g., smart watch or Google Glass), notebook computer, desktop computer, and/or other types of computing devices.

User device 220, in one embodiment, includes a user interface application 222, which may be utilized by user 202 to access applications available over the network 260 and to provide instructions to service provider server 280 over network 260. In one aspect, user 202 may login to an account related to user 202 via user interface application 222.

In one implementation, user interface application 222 comprises a software program, such as a graphical user interface (GUI), executable by a processor that is configured to interface and communicate with service provider server 280 via network 260. In another implementation, user interface application 222 comprises a browser module that provides a network interface to browse information available over network 260. For example, user interface application 222 may be implemented, in part, as a web browser to view information available over network 260.

User device 220, in several embodiments, includes service provider application 224, which allows user 202 to interact with the service provider. Service provider application 224 may be downloaded to user device 220 from an app store and/or from a service provider website and installed on user device 220. The service provider application 224, in various embodiments, allows user 202 to track his or her balance with the service provider, check in to pay from user device 220, order ahead at restaurants, choose how to pay for an item, and/or send money to a friend.

The service provider application 224 may be implemented by one or more hardware components, software components, firmware components, and/or a combination thereof. For example, the service provider application 224 may be implemented by a computer program stored on one or more types of computer-readable storage media to be executed by one or more processors of the user device 220.

User device 220, in various embodiments, may include other applications 226 as may be desired in one or more embodiments of the present disclosure to provide additional features available to user 202. In one example, such other applications 226 may include security applications for implementing client-side security features, calendar application, contacts application, location-based services application, programmatic client applications for interfacing with appropriate application programming interfaces (APIs) over the network 260, and/or various other types of generally known programs and/or software applications. In still other examples, other applications 226 may interface with user interface application 222 for improved efficiency and convenience.

User device 220, in one embodiment, may include at least one user identifier 228, which may be implemented, for example, as operating system registry entries, cookies associated with user interface application 222, identifiers associated with hardware of user device 220, or various other appropriate identifiers. User identifier 228 may include one or more attributes related to user 202, such as personal information related to user 202 (e.g., one or more user names, passwords, photograph images, biometric IDs, addresses, phone numbers, social security number, etc.). In various implementations, user identifier 228 may be passed with a user login request to service provider server 280 via network 260, and user identifier 228 may be used by service provider server 280 to associate user 202 with a particular user account maintained by service provider server 280.

User device 220, in various embodiments, includes a geo-location component 229 configured to determine, track, monitor, and/or provide an instant geographical location of user device 220. User device 220 can determine a current location of user device 220 using various location determination techniques. For example, user device 220 can determine a current location using a Global Positioning System (GPS) signal, by triangulating positions of wireless access points, or by a current cell identifier of a cellular communications network.

In one implementation, the geographical location may include GPS coordinates, zip-code information, area-code information, street address information, and/or various other generally known types of location information. In one example, the location information may be directly entered into user device 220 by user 202 via a user input component, such as a keyboard, touch display, and/or voice recognition microphone. In another example, the location information may be automatically obtained and/or provided by the user device 220 via an internal or external monitoring component that utilizes a GPS, which uses satellite-based positioning, and/or assisted GPS (A-GPS), which uses cell tower information to improve reliability and accuracy of GPS-based positioning. In other embodiments, the location information may be automatically obtained without the use of GPS. In some instances, cell signals or wireless signals are used. For example, location information may be obtained by checking in using user device 220 via a check-in device at a location, such as a beacon. This helps to save battery life and to allow for better or more accurate indoor location determination where GPS typically does not work.

Service provider server 280, in various embodiments, may be maintained by a service provider that provides online services and/or processing for information and/or financial transactions. As such, service provider server 280 includes a service application 282, which may be adapted to interact with the user device 220 over the network 260 to facilitate the receipt and analysis of information from user device 220. In one example, service provider server 180 may be provided by a service provider such as PayPal®, Inc. of San Jose, Calif., USA.

The service provider server 280, in one embodiment, may be configured to maintain one or more user accounts and merchant accounts in an account database 286 each of which may include account information 288 associated with one or more individual users (e.g., user 202) and merchants. For example, account information 288 may include private financial information of user 202, such as one or more account numbers, passwords, credit card information, banking information, or other types of financial information, which may be used to facilitate financial transactions between user 202 and a merchant. In various aspects, the methods and systems described herein may be modified to accommodate users and/or merchants that may or may not be associated with at least one existing user account and/or merchant account, respectively.

In one implementation, the user 202 may have identity attributes stored with the service provider server 280, and user 202 may have credentials to authenticate or verify identity with the service provider server 280. User attributes may include personal information, banking information and/or funding sources. In various aspects, the user attributes may be passed to the service provider server 280 as part of a login, search, selection, purchase, and/or payment request, and the user attributes may be utilized by the service provider server 280 to associate user 202 with one or more particular user accounts maintained by the service provider server 280.

In various embodiments, service provider server 280 utilizes a pregenerated token application 290 to determine whether or not to authenticate user 202. In various embodiments, the pregenerated token application 290 receives a request for pregenerated tokens from user 202 and generates a list of pregenerated tokens. The pregenerated token application 290 can download or otherwise transmit the list of pregenerated tokens to the user device 220 in response to the request. User device 220 can in turn save the downloaded list of pregenerated tokens to a memory of user device 220 for use in accessing an application (e.g., service provider application 224). For example, when user 202 opens service provider application 224, the service provider application 224 can cause the user device 220 to select one of the pregenerated tokens from the list of pregenerated tokens for use in accessing the service provider application 224. User device 220 can select a pregenerated token from the list based on conditions of use associated with the tokens.

Once the appropriate pregenerated token is entered, the pregenerated token application 290 receives the pregenerated token. The pregenerated token application 290 checks whether the conditions of use attached to the pregenerated token are met (i.e., that the token is valid for use by user 202 at the time log in is requested). For example, if a condition of use associated with the received pregenerated token is that user device 220 must be in the United States when the token is used, pregenerated token application 290 can determine the location of user device 220 (e.g., by receiving location information from user device 220). If the user device 220 is determined to be in the United States, user 202 is granted access to service provider application 224. If the user device 220 is determined to be in India, however, pregenerated token application 290 denies access to user 202. In some embodiments, the service provider notifies the user 202 of the unauthorized attempt to log in to his or her account so that user 202 can change usernames and/or passwords. In certain embodiments, the service provider may be able to track the attacker to a specific location.

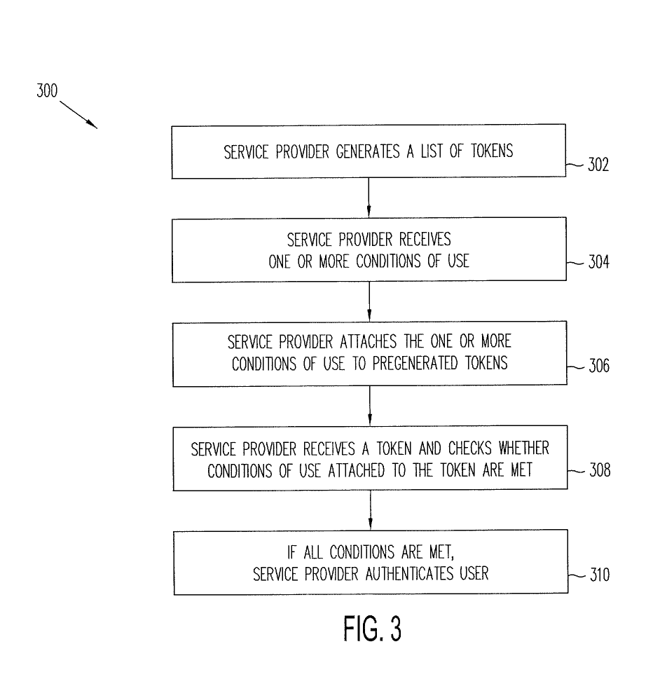

Referring now to FIG. 3, a flowchart of a method 300 of authenticating a user with a pregenerated token is illustrated according to an embodiment of the present disclosure. In various embodiments, the user 202 registers with a service provider, which runs service provider application 224. Registration may include signing up for the service and agreeing to any terms required by the service provider, such as through user device 220. In one embodiment, the user device 220 is a mobile computing device, such as a smartphone, a PC, or a computing tablet. In other embodiments, registration may be done completely through the user device 220, partially through the user device 220, or without using the user device 220, such as through a phone call or in-person visit to a representative of the service provider.

The user 202 may be requested to provide specific information for registration, such as, but not limited to, a name, address, phone number, email address, picture, a user name for the account, a password or PIN for the account, or other biometric identification such as a fingerprint. The type of information may depend on whether the user 202 already has an account with the service provider. Requested information may be entered through the user device 220 or other means, including voice or manual key entry. Once all the requested information is received and confirmed, the service provider may create an account for the user 202.

In various embodiments, the user 202 decides to enroll in the pregenerated token authentication service offered by the service provider. To encourage user 202 to sign up for the service, the service provider may offer more benefits or privileges because of the increased security that comes with the service. For example, user 202 may have higher transaction limits, pay lower service fees, and receive free shipping on purchases.

In response to the user's decision to enroll, at step 302, the service provider server 180 (e.g., pregenerated token application 290) generates a list of tokens for the user device 220 that user 202 used to request the service. In some embodiments, the pregenerated tokens are encrypted for increased security. The tokens are “pregenerated” because they are generated before they are used to authenticate user 202.

In several embodiments, the pregenerated tokens are based on the type of user device 220 that user 202 used to request the service. For example, a longer token or code may be generated for mobile devices versus a stationary device. Thus, pregenerated tokens to be stored on a laptop computer or on a smartphone will generally be longer and more complicated than tokens to be stored on a desktop computer. This is because tokens on mobile devices are more likely to be stolen or intercepted.

In some embodiments, the pregenerated tokens are based on the user 202. For example, a high-volume user or a privileged user will have a different set of pregenerated tokens than a low-volume user. Longer and more complicated pregenerated tokens or codes will be issued to high-volume users since high-volume users are more likely to be a subject of identity theft and require increased security and protection.

In other embodiments, the pregenerated tokens are language-specific. That is, a user in France (or a French-speaking user) may be issued tokens in French, while a user in Spain (or a Spanish-speaking user) may be issued tokens in Spanish.

According to certain embodiments, the pregenerated tokens are associated with one or more conditions of use. For example, a condition of use that is automatically associated with the pregenerated tokens is user device 220. That is, the token must be used in conjunction with user device 220 for user 202 to be authenticated. Each set of pregenerated tokens is linked to a specific device.

Should user 202 (or any other user) attempt to log in to service provider application 224 on another device, access to application 224 will be denied. Therefore, if a thief manages to steal the username, password, and token list of user 202, but does not have the correct user device identifier (i.e., the device identifier associated with user device 220), the thief will not be able to gain access to user 202's account with the service provider.

In some embodiments, the one or more conditions of use are selected by user 202. At step 304, service provider server 280 receives one or more conditions of use. Suitable conditions of use include location, the number of transactions, and time.

In some embodiments, user 202 may select location as a condition of use. That is, user device 220 must be determined to be at a specific location attached to the token before user 202 is authenticated. In one implementation, user 202 may release geo-location information to the user device 220 (or service provider server 280) by, e.g., setting release parameters. In one aspect, the user geo-location information includes user information related to a physical location or position of the user device 220, which are passed to the user device 220 (or service provider server 280 via the network 260). The user geo-location information may include GPS coordinates (e.g., longitude and latitude) inherent to the user device 220, such as a mobile cellular phone, and/or zip-code information. The user geo-location information may include user identifier information identifying the user 202. The user 202 may manually set geo-location information, such as a zip code and/or longitude and latitude coordinates. In various embodiments, the location of user 202 can serve as an additional layer of security for user authentication.

In alternative embodiments, user 202 may select the number of transactions as a condition of use. In other words, the pregenerated token is associated with a specific number of times of use. For example, a pregenerated token can be valid for use three times. At the fourth time, should user 202 (or any other user) attempt to use the token, authentication is denied. The user device 220 and service provider server 280 can distinguish each log in request and therefore can determine how many times the token has been used. The service provider server 280 can trace the number of requests so that it can prevent re-use of the token.

In some embodiments, as described above, time can be the condition of use. In various embodiments, the token can also include, as a further condition of use, a time period within which the token is valid, and outside of which it cannot be used. This time condition of use can be combined with location and/or the number of times the token can be used, or could be used on its own without a limit in the number of transactions or location, so that any number of transactions or any location can be used using the same token, provided the token is used within the specified period.

At step 306, the service provider server 280 associates or attaches the one or more conditions of use to each of the pregenerated tokens in the list.

When user 202 returns to the service provider homepage to log in at a later time, user 202 enters his or her username and password. User device 220 selects the appropriate token to use based on current conditions and the conditions of use attached to the pregenerated tokens. For example, user device 220 may determine the current location of user device 220, and select the token for that location.

At step 308, the service provider server 280 receives the token and checks whether the conditions of use attached to the token are met. If all the conditions are met, the service provider authenticates user 202 and grants access to service provider application 224. For example, in a case where the only condition of use is the number of times a token can be used, the service provider server 180 checks the number of uses that the token was initially valid for, and the number of times that it has been used already. If it is still valid for one or more further uses, then the service provider server 180 provides access to user 202. The number of times the token is used is therefore tracked, and when the token has been used as many times as it was valid for, then it becomes invalid and cannot be used to authenticate to service provider application 224 anymore.

Advantageously, the described systems and methods authenticate a user without the user having to carry a separate token-generating device. A user simply needs his or her user device (“something the user has”) and his or her username and password (“something the user knows”). Pregenerated tokens that are wed to specific user devices provide increased security, are easy to use and require little action from the user. The pregenerated tokens are typically short-lived so an unauthorized user cannot do much with a stolen token.

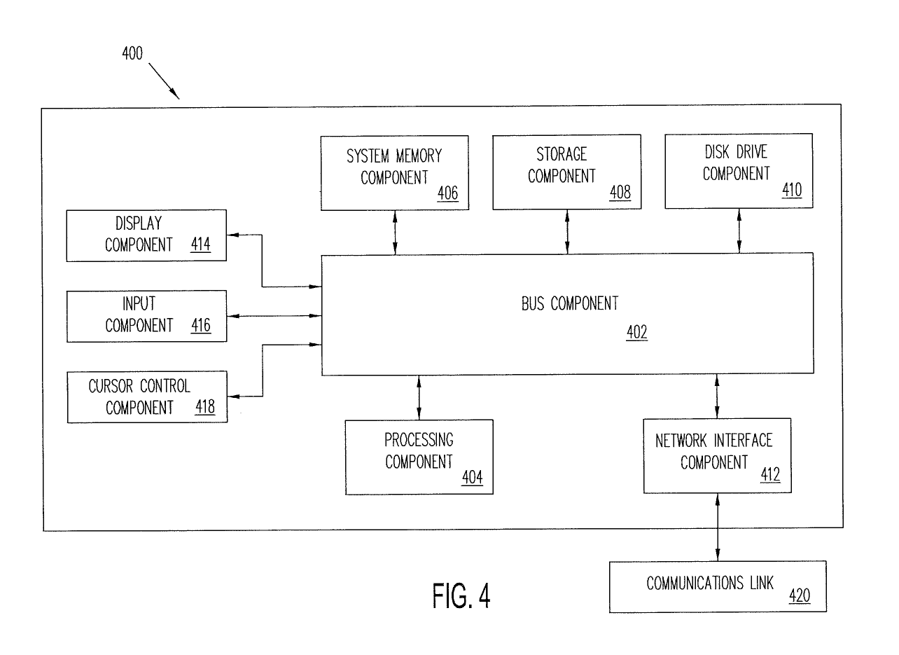

Referring now to FIG. 4, illustrated is a block diagram of a system 400 suitable for implementing embodiments of the present disclosure, including user device 220 and service provider server or device 280. System 400, such as part of a cell phone, a tablet, a personal computer and/or a network server, includes a bus 402 or other communication mechanism for communicating information, which interconnects subsystems and components, including one or more of a processing component 404 (e.g., processor, micro-controller, digital signal processor (DSP), etc.), a system memory component 406 (e.g., RAM), a static storage component 408 (e.g., ROM), a network interface component 412, a display component 414 (or alternatively, an interface to an external display), an input component 416 (e.g., keypad or keyboard), a cursor control component 418 (e.g., a mouse pad).

In accordance with embodiments of the present disclosure, system 400 performs specific operations by processor 404 executing one or more sequences of one or more instructions contained in system memory component 406. Such instructions may be read into system memory component 406 from another computer readable medium, such as static storage component 408. In other embodiments, hard-wired circuitry may be used in place of or in combination with software instructions for implementation of one or more embodiments of the disclosure.

Logic may be encoded in a computer readable medium, which may refer to any medium that participates in providing instructions to processor 404 for execution. Such a medium may take many forms, including but not limited to, non-volatile media, volatile media, and transmission media. In various implementations, volatile media includes dynamic memory, such as system memory component 406, and transmission media includes coaxial cables, copper wire, and fiber optics, including wires that comprise bus 402. Memory may be used to store pregenerated tokens and their associated conditions of use and information associated with making payments, or conducting financial transactions. In one example, transmission media may take the form of acoustic or light waves, such as those generated during radio wave and infrared data communications. Some common form of computer readable media include, for example, RAM, PROM, EPROM, FLASH-EPROM, any other memory chip or cartridge, carrier wave, or any other medium from which a computer is adapted to read.

In various embodiments of the disclosure, execution of instruction sequences to practice the disclosure may be performed by system 400. In various other embodiments, a plurality of systems 400 coupled by communication link 420 (e.g., network 160 of FIG. 1, LAN, WLAN, PTSN, or various other wired or wireless networks) may perform instruction sequences to practice the disclosure in coordination with one another. Computer system 400 may transmit and receive messages, data, information and instructions, including one or more programs (i.e., application code) through communication link 420 and communication interface 412. Received program code may be executed by processor 404 as received and/or stored in disk drive component 410 or some other non-volatile storage component for execution.

In view of the present disclosure, it will be appreciated that various methods and systems have been described according to one or more embodiments for authenticating a user with a pregenerated token.

Although various components and steps have been described herein as being associated with user device 220 and service provider server or device 280 of FIG. 2, it is contemplated that the various aspects of such servers illustrated in FIG. 2 may be distributed among a plurality of servers, devices, and/or other entities.

Where applicable, various embodiments provided by the present disclosure may be implemented using hardware, software, or combinations of hardware and software. Also where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the spirit of the present disclosure. In addition, where applicable, it is contemplated that software components may be implemented as hardware components, and vice-versa.

Software in accordance with the present disclosure, such as program code and/or data, may be stored on one or more computer readable mediums. It is also contemplated that software identified herein may be implemented using one or more specific purpose computers and/or computer systems, networked and/or otherwise. Where applicable, the ordering of various steps described herein may be changed, combined into composite steps, and/or separated into sub-steps to provide features described herein.

The various features and steps described herein may be implemented as systems comprising one or more memories storing various information described herein and one or more processors coupled to the one or more memories and a network, wherein the one or more processors are operable to perform steps as described herein, as non-transitory machine-readable medium comprising a plurality of machine-readable instructions which, when executed by one or more processors, are adapted to cause the one or more processors to perform a method comprising steps described herein, and methods performed by one or more devices, such as a hardware processor, mobile device, server, and other devices described herein.

What is claimed is:

1. A system for authenticating a user comprising:
a non-transitory memory storing instructions; and
one or more hardware processors coupled to the non-transitory memory and configured to read instructions from the non-transitory memory to cause the system to perform operations comprising:
receiving, from a user device, a pregenerated token for authentication, wherein the pregenerated token is stored on the user device and associated with a user account;
determining that there are one or more conditions of use associated with the received pregenerated token, wherein the one or more conditions of use comprise one or more of time, location, and number of uses;
in response to determining that there are one or more conditions of use associated with the received pregenerated token, confirming that the one or more conditions of use are met; and
in response to confirming that the one or more conditions of use are met, granting access to the user account.

2. The system of claim 1, wherein the operations further comprise receiving a request from the user device for pregenerated tokens.

3. The system of claim 2, wherein the operations further comprise generating a list of pregenerated tokens for the user device.

4. The system of claim 3, wherein the list of pregenerated tokens is based on a type of user device, a user, or both.

5. The system of claim 4, wherein the list of pregenerated tokens is based on a language that the user speaks.

6. The system of claim 3, wherein the list of pregenerated tokens is tied to the user device.

7. The system of claim 3, wherein the operations further comprise receiving the one or more conditions of use and attaching the one or more conditions of use to each of the pregenerated tokens in the list.

8. The system of claim 3, wherein the operations further comprise transmitting the list of pregenerated tokens to the user device.

9. The system of claim 3, wherein the operations further comprise causing the user device to select one of the pregenerated tokens from the list.

10. A method of authenticating a user with pregenerated tokens comprising:
receiving a pregenerated token for authentication from a user device;
receiving a device identifier associated with the user device;
verifying that the device identifier is associated with the received pregenerated token;
determining that there are one or more conditions of use associated with the received pregenerated token, wherein the one or more conditions of use comprise one or more of time, location, and number of uses;
in response to determining that there are one or more conditions of use associated with the received pregenerated token, confirming that the one or more conditions of use are met; and
in response to confirming that the one or more conditions of use are met, granting access to a user account associated with the received pregenerated token.

11. The method of claim 10, further comprising receiving a request from the user device for pregenerated tokens and generating a list of pregenerated tokens for the user device.

12. The method of claim 11, wherein generating the list of pregenerated tokens comprises one or more of determining a type of the user device, determining whether a user is a high-volume user, and determining a language that a user speaks.

13. The method of claim 11, further comprising receiving the one or more conditions of use from the user device and attaching the one or more conditions of use to each of the pregenerated tokens in the list.

14. The method of claim 11, further comprising transmitting the list of pregenerated tokens to the user device.

15. The method of claim 11, further comprising causing the user device to select one of the pregenerated tokens from the list.

16. A non-transitory machine-readable medium having stored thereon machine-readable instructions executable to cause a machine to perform operations comprising:
receiving a pregenerated token for authentication from a user via a user device;
determining that there are conditions of use associated with the received pregenerated token, wherein the conditions of use comprise time, location, and number of uses;
in response to determining that there are conditions of use associated with the received pregenerated token, concluding that all the conditions of use are not met; and
in response to concluding that all the conditions of use are not met, rejecting the user.

17. The non-transitory machine-readable medium of claim 16, wherein the operations further comprise notifying a user associated with the pregenerated token of the rejected user.

18. The non-transitory machine-readable medium of claim 16, wherein the pregenerated token is based on a type of user device, a user, or both.

19. The non-transitory machine-readable medium of claim 16, wherein the pregenerated token is tied to a user device that requests generation of the pregenerated token.

20. The non-transitory machine-readable medium of claim 16, wherein the operations further comprise tracking a location of the user.
